(19) United States
(12) Patent Application Publication
(10) Pub. No.: US 2015/0150246 A1
(43) Pub. Date: Jun. 4, 2015

(54) USE OF INSECT GROWTH REGULATORS IN COCKROACH CONTROL

(71) Applicants: Robert Akos Suranyi, Minneapolis, MN (US); Donald Larry Sundquist, Minnetonka, MN (US); Ian Douglas Thorburn, Maple Grove, MN (US)

(72) Inventors: Robert Akos Suranyi, Minneapolis, MN (US); Donald Larry Sundquist, Minnetonka, MN (US); Ian Douglas Thorburn, Maple Grove, MN (US)

(73) Assignee: MCLAUGHLIN GORMLEY KING COMPANY, Minneapolis, MN (US)

(21) Appl. No.: 14/558,003

(22) Filed: Dec. 2, 2014

Related U.S. Application Data
(60) Provisional application No. 61/911,147, filed on Dec. 3, 2013.
(60) Provisional application No. 61/928,134, filed on Jan. 16, 2014.

(51) Int. Cl. A01N 25/08; A01N 43/90; A01N 43/40

(52) U.S. Cl. CPC A01N 25/08; A01N 43/40; A01N 43/90

(57) ABSTRACT

A method of reducing a population of cockroaches in which a cockroach bait is provided. The cockroach bait contains a bait matrix, an insect growth regulator, and a non-insect growth regulator insecticide. The method includes placing the cockroach bait in a location where cockroaches are periodically present, to thereby reduce the population of cockroaches in the vicinity of the location. Cockroach baits containing a bait matrix, an insect growth regulator, and a non-insect growth regulator insecticide are provided. Methods and cockroach baits containing one or more insect growth regulators in which the one or more insect growth regulators are the only active ingredients are also provided.

### FIELD OF THE INVENTION

This invention relates to the field of cockroach control. Specifically, the invention relates to controlling cockroaches using growth regulators.

### BACKGROUND OF THE INVENTION

The German cockroach is medically the most important pest of urban environments (Rust 2008). German cockroaches are considered a major public health pest because of the wide-ranging impact of German cockroach infestations on human health. In general, chronic German cockroach infestations are associated with unsanitary living conditions, and as a consequence, German cockroaches play a central role in the epidemiology of many food-borne diarrheal diseases, such as Entamoeba histolytica and Giardia lamblia (Graczyk et al. 2005). German cockroach infestations were also linked to allergic respiratory diseases, especially in inner-city environments that are exposed to severe and persistent infestations of German cockroaches (Arbes at al. 2004).

The life cycle of German cockroaches follows a simple or incomplete metamorphosis comprising the following life stages: egg, immature, and adult. The immature stage of insects undergoing incomplete metamorphosis is called the nymph stage. The nymph stage is morphologically similar to the adult stage except for a smaller size and the lack of wings and genitalia. An important characteristic of incomplete metamorphosis is that both the immature and adult stages inhabit similar ecological niches, e.g., acquire resources in a similar manner. Consequently, damage caused by the different life stages only differs in the degree of damage rather than the type of damage.

One of the most important ecological attributes of German cockroaches is their tendency to aggregate (the preference of individuals to live under high density conditions in one place but without cooperation in nest construction and offspring care) (Bell et al. 2007). Aggregation improves reproductive success (mating), allows microclimate control (temperature and humidity), provides additional food resources (exuviae, dead or molting conspecifics, and fecal pellets), and improves growth and development of early instars (Gunn 1935, Schal et al. 1997, Dambach and Goehlen 1999, Kopanic et al. 2001, Appel et al. 2008). German cockroaches show preference towards harborages (places of aggregation) that are warm (70° F./21° C.), dark, humid, and undisturbed. Since these habitats are usually spatially well defined and not uniformly distributed in an urban environment, German cockroach infestations show a corresponding pattern of non-uniform distribution (Rivault 1997, Rivault et al. 1999). Aggregation is facilitated by an aggregation pheromone blend that is excreted in the feces of German cockroaches. In general, German cockroaches spend approximately 75% of their time in harborages, areas that accumulate the highest amount of faeces, and thus, contain the highest concentration of aggregation pheromone which further promotes the development of the spatially fragmented pattern of German cockroach infestations (Stejskal 1997, Bell et al. 2007).

German cockroaches are omnivores consuming both plant and animal based food resources and thrive under unsanitary conditions. Generally, food resources available under field conditions are dominated by saturated and unsaturated fat content with low amounts of proteins and carbohydrates leading to nutritionally stressed field populations (Kells et al. 1999).

German cockroaches are opportunistic foragers and exploit the nearest food resources first, although adults and large nymphs can commonly exploit food resources as far as 3.3 m (11 ft) away from their harborage (Cloarec and Rivault 1991). In general, adult males have the largest foraging range whereas first instar nymphs generally remain close to or in the harborage and obtain most of their nutritional needs via facultative coprophagy (feeding on conspecific fecal materials) (Cloarec and Rivault 1991, Kopanic et al. 2001). With the exception of adult females, all other life stages feed continuously. Most of the food intake of adult females is concentrated during the first 10 days of their reproductive cycle (Schal et al. 1997). Consequently, females spend approximately 60 to 75% of their reproductive life inside harborages without feeding.

Cockroach infestations do not occur in a vacuum, and correspondingly an effective control response should be proactive, multifaceted and include one or more of the following: (1) exclusion; (2) sanitation; (3) inspection; (4) education; (5) physical control, and (6) chemical control.

German cockroach, Blattella germanica, management has been revolutionized by the introduction of toxic baits, a technology that delivers active ingredients in a highly palatable food matrix via ingestion as opposed to the primarily contact mode of action that characterized previous cockroach control tactics. Traditionally gel baits consist of two major components: the active ingredient and the food delivery platform (matrix). While both components contribute to the efficacy of the overall technology the underlying mode of action of gel baits is their ability to provide an attractive and competitive food source for the cockroach population that also delivers a lethal dose of the insecticide during a single feeding bout. An effective bait matrix can be viewed as an insect diet that promotes rapid exploration and exploitation but does not necessarily provide nutrients for optimal growth, development, and reproduction. Cohen (2004) lists the following critical attributes for a successful insect diet that also apply to cockroach baits: (1) it projects all necessary sensory requirements for the target insect; (2) it fulfills the dietary needs of the insect under diverse dietary environments; and (3) it is stable in storage as well as in the application environment. On the operational side, the consistency of the matrix must facilitate easy dispensing of the gel bait as well as sufficient surface adhesion to allow placement onto vertical surfaces, without a questionable odor profile and surface staining.

German cockroaches are omnivores who are able to obtain their nutrient requirements (protein/carbohydrate/lipid) from highly diverse sources over multiple feeding events. Foraging behavior in German cockroaches is driven by the nutritional status of the individual to compensate for existing nutrient imbalance and to meet the nutritional demand of the life stage (Bell et al. 2007). An acceptable diet for German cockroaches contains 11-40% proteins (McCay 1938, Noland and Baumann 1951, Haydak 1953, Hamilton and Schal 1988), 11-50% carbohydrates (Kopanic at al. 2001), and 4% lipids (Cooper and Schal 1992). In addition to macronutrients, effective diets can contain both water-soluble and lipid-soluble vitamins, minerals, feeding stimulants (e.g., flavoring agents), protective ingredients (e.g., antioxidants, emulsifiers, antimicrobial agents, chelating agents, etc.), texture components (e.g., cellulose and various gelling agents), and water. In general, the above mentioned components can be supplied via holidic diet forms where all components are completely known and characterized, oligidic diet forms where all components are not fully known or characterized, or meridic diet forms where some components are well characterized while others are not.

In the laboratory, long-term nutritional needs of cockroaches can be provided by various brands of dog food and or rat chow. These generally contain >20% crude proteins, e.g., PURINA® brand puppy chow contains 25% crude protein, 7% crude fat and 9% fibers. Among minor ingredients, dog chow often contains one or more of the following: whole grain corn, corn gluten meal, chicken by-product meal, animal fat preserved with mixed-tocopherols (form of Vitamin E), soybean meal, egg and chicken flavor, brewer's rice, barley, animal digest, calcium phosphate, fish oil, calcium carbonate, dried yeast, salt, potassium chloride, choline chloride, L-lysine monohydrochloride, L-ascorbyl-2-polyphosphate, zinc sulfate, Vitamin E supplement, ferrous sulfate, Yellow 6, methionine, Yellow 5, manganese sulfate, niacin, Red 40, Vitamin A supplement, Blue 2, copper sulfate, calcium pantothenate, garlic oil, pyridoxine hydrochloride, Vitamin B-12 supplement, thiamine mononitrate, Vitamin D-3 supplement, riboflavin supplement, calcium iodate, menadione sodium bisulfite complex, folic acid, biotin, and sodium selenite. The dietary value of these non-specific cockroach diets is influenced by the quality, quantity and wholesomeness of essential and non-essential ingredients present in the product along with the impact that processing can exert on the availability of these components in the final form to all life stages of German cockroaches. Resource acquisition, especially by early stage nymphs is hindered by product forms that have a smooth hard surface structure that can act as a mechanical barrier (Cooper and Schal 1992), e.g., by limiting incision opportunities for life stages with smaller and less powerful mandibular structures.

Another common diet for cockroaches is peanut butter, which contains ˜22% protein, ˜53.7% fat, ˜18% carbohydrates, ˜3% ash, and other minor components.

Since unsanitary conditions are prerequisite for chronic German cockroach infestations, the nutritional heterogeneity of food resources within the context of German cockroach foraging can still create localized nutritional stresses in cockroach populations.

In summary, gel baits exploit normal foraging feeding behavior of cockroaches to transfer a lethal dose of the active ingredient during a single feeding bout. The active ingredient is the other major component that determines the efficacy of cockroach gel baits under the “attract and kill” model of toxic baiting.

The current invention expands this model by including a sterilization (birth control) element into the mode of action.

### SUMMARY OF THE INVENTION

The invention provides a method of reducing a population of cockroaches comprising: providing a cockroach bait comprising a bait matrix, an insect growth regulator, and a non-insect growth regulator; and placing the cockroach bait in a location where cockroaches are periodically present, to thereby reduce the population of cockroaches in the vicinity of the location, wherein the non-insect growth regulator insecticide is an avermectin or milbemycin insecticide.

The invention provides a cockroach bait comprising a bait matrix, an insect growth regulator, and a non-insect growth regulator insecticide, wherein the non-insect growth regulator insecticide is an avermectin or milbemycin insecticide.

The invention provides a method of reducing a population of cockroaches comprising: providing a cockroach bait comprising a bait matrix and one or more insect growth regulators; and placing the cockroach bait in a location where cockroaches are periodically present, to thereby reduce the population of cockroaches in the vicinity of the location, wherein the one or more insect growth regulators are the only active ingredients.

The invention provides a cockroach bait comprising a bait matrix and one or more insect growth regulators, wherein the one or more insect growth regulators are the only active ingredients.

It is to be understood that both the foregoing general description and the following detailed description are exemplary and explanatory and are intended to provide further explanation of the invention as claimed.

### DETAILED DESCRIPTION

In particular, the invention provides a method of reducing a population of cockroaches comprising: providing a cockroach bait comprising a bait matrix, an insect growth regulator, and a non-insect growth regulator; and placing the cockroach bait in a location where cockroaches are periodically present, to thereby reduce the population of cockroaches in the vicinity of the location, wherein the non-insect growth regulator insecticide is an avermectin or milbemycin insecticide. The cockroaches consume the bait, travel back to their places of aggregation, and defecate feces in their places of aggregation. The feces contain some insect growth regulator and when other cockroaches consume it or come in contact with it, their reproduction is inhibited and the population of cockroaches is reduced. Insect growth regulators that can be used include, but are not limited to, juvenile hormone analogues such as pyriproxyfen, hydroprene, kinoprene, methoprene, and fenoxycarb; inhibitors of chitin biosynthesis such as bistrifluron, chlorfluazuron, diflubenzuron, flucycloxuron, flufenoxuron, hexaflumuron, lufenuron, novaluron, noviflumuron, teflubenzuron, triflumuron, and buprofezin; moulting disruptors such as cyromazine; ecdysone receptor agonists such as chromafenozide, halofenozide, methoxyfenozide, and tebufenozide; mite growth inhibitors such as clofentezine, hexythiazox, diflovidazin; and azadirachtin, salts thereof, isomers thereof, and combinations thereof. In one embodiment, the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof. In one embodiment, the insect growth regulator is selected from pyriproxyfen, hydroprene, kinoprene, methoprene, and fenoxycarb. In an embodiment, the insect growth regulator is pyriproxyfen. The insect growth regulator preferably is present in the bait at a concentration of from 0.05 to 5 percent by weight, more preferably at a concentration from 0.25 to 1 percent by weight.

The non-insect growth regulator insecticide can be an avermectin insecticide. The avermectin insecticide can be selected from abamectin, emamectin benzoate, emamectin, ivermectin, selamectin, doramectin, isomers thereof, salts thereof, and combinations thereof. The avermectin insecticide can be selected from abamectin, emamectin benzoate, emamectin, ivermectin, selamectin, doramectin, salts thereof, and combinations thereof. The non-insect growth regulator insecticide can be a milbemycin insecticide. The milbemycin insecticide can be selected from lepimectin, milbemectin, milbemycin oxime, moxidectin, nemadectin, isomers thereof, salts thereof, and combinations thereof. The milbemycin insecticide can be selected from lepimectin, milbemectin, milbemycin oxime, moxidectin, nemadectin, salts thereof, and combinations thereof.

In one embodiment, the non-insect growth regulator insecticide is selected from abamectin, emamectin benzoate, lepimectin, and milbemectin. In an embodiment, the non-insect growth regulator insecticide is abamectin.

The non-insect growth regulator insecticide preferably is present at a concentration of from 0.01 to 5 percent by weight, more preferably at a concentration from 0.025 to 1 percent by weight. The bait can also contain synergists such as piperonyl butoxide and n-octyl bicycloheptene dicarboximide.

In an embodiment, the insect growth regulator is pyriproxyfen and the non-insect growth regulator insecticide is abamectin. In one embodiment, pyriproxyfen and abamectin are the only active ingredients. In an embodiment, pyriproxyfen is present in the bait at a concentration of from 0.05 to 1 percent by weight and the abamectin is present in the bait at a concentration of from 0.025 to 1 percent by weight. In one embodiment, the pyriproxyfen is present in the bait at a concentration of from 0.05 to 1 percent by weight and the abamectin is present in the bait at a concentration of from 0.025 to 0.25 percent by weight. In an embodiment, the pyriproxyfen is present in the bait at a concentration of 0.5 percent by weight and the abamectin is present in the bait at a concentration of 0.05 percent by weight. In one embodiment, the cockroaches are German cockroaches.

In one embodiment, the population of cockroaches in the vicinity of the location is reduced by 30% or more two months after the cockroach bait has been placed. In an embodiment, the population of cockroaches in the vicinity of the location is reduced by 50% or more two months after the cockroach bait has been placed. In one embodiment, the population of cockroaches in the vicinity of the location is reduced by 70% or more two months after the cockroach bait has been placed. In an embodiment, the population of cockroaches in the vicinity of the location is reduced by 90% or more two months after the cockroach bait has been placed.

In one embodiment, the population of cockroaches in the vicinity of the location is reduced by 30% or more one year after the cockroach bait has been placed. In an embodiment, the population of cockroaches in the vicinity of the location is reduced by 50% or more one year after the cockroach bait has been placed. In one embodiment, the population of cockroaches in the vicinity of the location is reduced by 70% or more one year after the cockroach bait has been placed. In an embodiment, the population of cockroaches in the vicinity of the location is reduced by 90% or more one year after the cockroach bait has been placed.

The invention provides a cockroach bait comprising a bait matrix, an insect growth regulator, and a non-insect growth regulator insecticide, wherein the non-insect growth regulator insecticide is an avermectin or milbemycin insecticide. In an embodiment, the insect growth regulator is present in the bait at a concentration of from 0.05 to 5 percent by weight. In one embodiment, the insect growth regulator is present in the bait at a concentration of from 0.25 to 1 percent by weight.

In one embodiment, the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, isomers thereof, and combinations thereof. In one embodiment, the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof. In an embodiment, the insect growth regulator is selected from pyriproxyfen, hydroprene, kinoprene, methoprene, and fenoxycarb. In one embodiment, the insect growth regulator is pyriproxyfen.

In an embodiment, the non-insect growth regulator insecticide is present in the bait at a concentration of from 0.01 to 5 percent by weight. In one embodiment, the non-insect growth regulator insecticide is present in the bait at a concentration of from 0.025 to 1 percent by weight. In an embodiment, the non-insect growth regulator insecticide is an avermectin insecticide. In one embodiment, the avermectin insecticide is selected from abamectin, emamectin benzoate, emamectin, ivermectin, selamectin, doramectin, isomers thereof, salts thereof, and combinations thereof. In one embodiment, the avermectin insecticide is selected from abamectin, emamectin benzoate, emamectin, ivermectin, selamectin, doramectin, salts thereof, and combinations thereof.

In an embodiment, the non-insect growth regulator insecticide is a milbemycin insecticide. In one embodiment, the milbemycin insecticide is selected from lepimectin, milbemectin, milbemycin oxime, moxidectin, nemadectin, isomers thereof, salts thereof, and combinations thereof. In one embodiment, the milbemycin insecticide is selected from lepimectin, milbemectin, milbemycin oxime, moxidectin, nemadectin, salts thereof, and combinations thereof.

In one embodiment, the non-insect growth regulator insecticide is selected from abamectin, emamectin benzoate, lepimectin, and milbemectin. In an embodiment, the non-insect growth regulator insecticide is abamectin.

A preferred bait contains pyriproxyfen (an insect growth regulator), abamectin (a toxicant), and an appropriate bait matrix. In an embodiment, pyriproxyfen and abamectin are the only active ingredients. In an embodiment, the pyriproxyfen is present in the bait at a concentration of from 0.05 to 1 percent by weight and the abamectin is present in the bait at a concentration of from 0.025 to 1 percent by weight. In one embodiment, the pyriproxyfen is present in the bait at a concentration of from 0.05 to 1 percent by weight and the abamectin is present in the bait at a concentration of from 0.025 to 0.25 percent by weight.

In one embodiment, the bait comprises abamectin at 0.05% and pyriproxyfen at 0.5% by weight. Efficacy was observed from 0.05 to 1.0% of pyriproxyfen. No higher doses were tested due to physical changes to the matrix, but higher amounts could be used by modifying the matrix. Pyriproxyfen is non-repellent so biologically 1.0% is not an absolute upper concentration limit.

The invention provides a method of reducing a population of cockroaches comprising: providing a cockroach bait comprising a bait matrix and one or more insect growth regulators; and placing the cockroach bait in a location where cockroaches are periodically present, to thereby reduce the population of cockroaches in the vicinity of the location, wherein the one or more insect growth regulators are the only active ingredients. In one embodiment, the one or more insect growth regulators are present in the bait at a total concentration of from 0.05 to 5 percent by weight. In an embodiment, the one or more insect growth regulators are present in the bait at a total concentration of from 0.25 to 1 percent by weight.

In one embodiment, the one or more insect growth regulators are selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, isomers thereof, and combinations thereof. In an embodiment, the one or more insect growth regulators are selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof. In an embodiment, the one or more insect growth regulators are selected from pyriproxyfen, hydroprene, kinoprene, methoprene, and fenoxycarb. In one embodiment, the bait comprises a single insect growth regulator and this insect growth regulator is pyriproxyfen. In an embodiment, the pyriproxyfen is present in the bait at a concentration of from 0.05 to 1 percent by weight. In one embodiment, the pyriproxyfen is present in the bait at a concentration of 0.5 percent by weight. In an embodiment, the cockroaches are German cockroaches.

In one embodiment, the population of cockroaches in the vicinity of the location is reduced by 30% or more two months after the cockroach bait has been placed. In an embodiment, the population of cockroaches in the vicinity of the location is reduced by 50% or more two months after the cockroach bait has been placed. In one embodiment, the population of cockroaches in the vicinity of the location is reduced by 70% or more two months after the cockroach bait has been placed. In an embodiment, the population of cockroaches in the vicinity of the location is reduced by 90% or more two months after the cockroach bait has been placed.

In one embodiment, the population of cockroaches in the vicinity of the location is reduced by 30% or more one year after the cockroach bait has been placed. In an embodiment, the population of cockroaches in the vicinity of the location is reduced by 50% or more one year after the cockroach bait has been placed. In one embodiment, the population of cockroaches in the vicinity of the location is reduced by 70% or more one year after the cockroach bait has been placed. In an embodiment, the population of cockroaches in the vicinity of the location is reduced by 90% or more one year after the cockroach bait has been placed.

The invention provides a cockroach bait comprising a bait matrix and one or more insect growth regulators, wherein the one or more insect growth regulators are the only active ingredients. In one embodiment, the one or more insect growth regulators are present in the bait at a total concentration of from 0.05 to 5 percent by weight. In an embodiment, the one or more insect growth regulators are present in the bait at a total concentration of from 0.25 to 1 percent by weight. In one embodiment, the one or more insect growth regulators are selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, isomers thereof, and combinations thereof. In an embodiment, the one or more insect growth regulator are selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof. In one embodiment, the one or more insect growth regulators are selected from pyriproxyfen, hydroprene, kinoprene, methoprene, and fenoxycarb. In an embodiment, the bait comprises a single insect growth regulator and this insect growth regulator is pyriproxyfen. In one embodiment, the pyriproxyfen is present in the bait at a concentration of from 0.05 to 1 percent by weight. In an embodiment, the pyriproxyfen is present in the bait at a concentration of 0.5 percent by weight.

Abamectin belongs to a group known as macrocyclic lactones of eight closely related molecules sharing the central structure of a macrocyclic lactone ring discovered from a soil fungus, Streptomyces avermitilis, by Merck & Co., Inc. in 1975 (Fisher and Mrozik 1992). Avermectin B1 or abamectin is a mixture of these molecules consisting of a minimum of 80% of avermectin B1a and not more than 20% of avermectin B1b.

The target site of abamectin is the nervous system via ingestion or limited contact route of entry. The precise mode of action of abamectin is unknown but abamectin binding increases the membrane permeability to chloride ions resulting in irreversible suppression of neuronal activity, and thus death. On the receptor level, abamectin interferes with the activity of two types of receptors, the glutamate-gated chloride ion channels and the gamma amino butyric acid (GABA)-gated chloride ion channels. Both of these receptors are responsible for regulating the chloride ion inflow into the nerve cells, an inflow that produces hyperpolarization (increasing the negative charge) of the membrane potential, and thus, exerting a temporal inhibition state in nerve impulse firing (allowing a short term phase of “rest and recovery” for the nerve cells). The primary target site of abamectin is the glutamate-gated chloride ion channels where abamectin binding slowly but irreversibly activates the opening of the Cl⁻ ion channels leading to long lasting hyperpolarization and suppression of neuronal activity resulting in ataxia, paralysis, and death (Bloomquist 2013).

Abamectin is a slower acting toxicant than other active ingredients commonly used in cockroach baiting with the exception of hydramethylnon and boric acid. For instance, in laboratory studies fipronil will be expected to provide 100% mortality of German cockroach males in a 24-hour post-bait introduction whereas under the same conditions abamectin will reach 100% mortality in 5 days.

Pyriproxyfen belongs to a chemically novel class of insecticides that mimic the action of insect growth and developmental hormones, known collectively as insect growth regulators or IGRs. Pyriproxyfen is a member of the subclass of juvenile hormone analogues (JHAs) which mimic the action of insect juvenile hormones that regulate the developmental processes of insects such as metamorphosis and reproduction. Pyriproxyfen is structurally unrelated to juvenile hormones but its biological activity mimics their effects. Application of a JHA results in a hormonal imbalance that leads to a cascade of physiological events that manifest in morphogenic, developmental and reproductive abnormalities.

The main effect of a JHA is the inhibition of metamorphosis. In addition, it is also involved in embryogenesis where the juvenile hormone is required for normal dorsal closure, differentiation of midgut and formation of larval cuticle, vitellogenesis, accessory reproductive gland activity, pheromone production and sexual behavior. In general, sensitivity to JHA occurs prior to each molt but the period of greatest sensitivity for metamorphic inhibition is during the last larval and nymphal instar since the commitment to the maturation pathway is induced by 20-hydroxyecdysone in conjunction with the absence of juvenile hormone. The extent and character of response is dependent upon the species, the time of application, dose, the mode of application, and the specific chemical used. In German cockroaches, a common morphological abnormality associated with IGR exposure is abnormal external wing development (wing twisting) resulting in wings with a slightly twisted appearance due to severely reduced knob-like structures. The severity of wing twisting is strongly correlated with reproductive inhibition (Reid et al. 1994, Lim and Yap 1996). Pyriproxyfen rapidly absorbs through the cuticle and is very stable in the environment.

Some of the advantages of the invention include:

(1) Targeting populations via an insect growth regulator such as pyriproxyfen rather than targeting individual cockroaches via toxicant only.

(2) Pyriproxyfen exposure does not inhibit consumption allowing a complete utilization of bait resource by the target population.

(3) Orally ingested pyriproxyfen was detected in the frass (excrement).

(4) A significant portion of ingested pyriproxyfen transferred into the frass (˜60% of pyriproxyfen ingested was confirmed to be present in the frass).

(5) Consumption of pyriproxyfen contaminated frass (secondary exposure) provided 100% suppression of the reproductive output of exposed cockroaches (reproductive output per normal female cockroach is ˜200 F1 individuals).

(6) Cockroaches of secondary exposure continued to deposit pyriproxyfen in the harborage to a degree that was sufficient to completely prevent the development and reproduction of newly hatched cockroaches for multiple generations.

(7) Pyriproxyfen creates a non-toxic contamination with residual IGR of potential harborage sites that are necessary to maintain and support chronic cockroach infestations but are generally inaccessible to toxic bait and other cockroach treatments. Long term contamination of these harborages with pyriproxyfen would not only impact existing cockroach populations but also would make these harborages inadequate for future cockroach colonization.

### EXAMPLES

### Example 1

Table 1 below shows the results of an investigation aimed at demonstrating the presence (horizontal transfer) of pyriproxyfen in faeces following the consumption of cockroach bait containing abamectin at 0.05% and pyriproxyfen at 0.50% weight concentrations.

Adult male German cockroaches were obtained directly from German cockroach colonies maintained in the laboratory after a brief exposure to CO2 to facilitate handling. Cohorts of similar age (˜11 weeks old), adult male cockroaches (˜300 individuals) were randomly selected and moved into holding containers (Lock&Lock containers, Lock&Lock Co. Ltd., Dallas, Tex., USA) using a pair of soft tissue forceps. Cockroaches were starved in holding containers for 48 hours. Following starvation, cockroaches were transferred into the fecal collection apparatus. The fecal collection apparatus consisted of two vertically connected holding containers (Lock&Lock Co. Ltd., Dallas, Tex., USA) separated by a mesh screen. Cockroaches were introduced into the upper compartment of the collection apparatus and fecal pellets were collected from the floor of the lower container. The floor of the lower container was sealed with aluminum foil to facilitate the removal of fecal pellets. Approximately 1.0 g of bait (containing 0.05% abamectin and 0.50% pyriproxyfen) was introduced into the upper compartment via a 20 ml square polystyrene weight boat (Lab Safety Supply, Janesville, Wis., USA) following the 48-hour starvation period. No alternative food source was provided to the cockroaches during the course of the faeces collection. Fecal pellets were collected weekly until a sufficient amount of faeces was obtained to achieve analytical quantification. Quantification of pyriproxyfen was made by standard high-performance liquid chromatography-mass spectrometry (HPLC-MS) developed for pyriproxyfen. Six (6) replications of fecal pellet collection were conducted.

TABLE 1

| | Concentration (ppm) of |
|---|---|
| Replication | pyriproxyfen in cockroach faeces |
| 1 | 325.7 |
| 2 | 418.0 |
| 3 | 352.7 |
| 4 | 215.3 |
| 5 | 669.0 |
| 6 | 226.3 |

The results displayed in Table 1 demonstrate that orally ingested pyriproxyfen is excreted and deposited into the faeces of German cockroaches.

### Example 2

Table 2 below shows the results of an investigation aimed at demonstrating that fecal pellets containing pyriproxyfen elicit reproductive inhibition in German cockroaches under laboratory conditions.

Fourth instar nymphs (25 males and 25 females) of German cockroaches were obtained directly from German cockroach colonies maintained in the laboratory after a brief exposure to CO2 to facilitate handling. Cockroaches were introduced into test arenas (33 cm×19 cm×10.8 cm clear plastic shoe boxes, The Container Store, Coppell, Tex., USA) using a pair of soft tissue forceps. Test arenas contained a single harborage composed of a 9 cm×13 cm piece of manila folder (OfficeMax, Naperville, Ill., USA) folded in half (length-wise) and a 30 ml square glass water bottle (Fisher Scientific, Pittsburgh, Pa., USA) filled with tap water and fitted with a cotton wick (Patterson Dental, Saint Paul, Minn., USA). A fine film of a 50:50 mixture of petroleum jelly/mineral oil was applied to the upper inner surface (˜9 cm in width) of test arenas to prevent escapes. Prior to introduction, cockroaches were starved for 48 hours in order to standardize feeding response to the bait introduction. Approximately 0.5 g of bait was introduced into each randomly assigned test arena in a 20 ml square polystyrene weight boat (Lab Safety Supply, Janesville, Wis., USA) following the 48-hour starvation period. No alternative food source was provided to the cockroaches during the course of the study. Cockroaches were fed with the bait containing 0.50% pyriproxyfen ad libitum. Harborages (contaminated with fecal pellets) were retrieved from the experimental arenas at the time of death of the last cockroach in a test arena. Faeces contaminated harborages were placed into clean test arenas to assess the efficacy of pyriproxyfen containing fecal pellets on the development of German cockroaches. An untreated control comprised of a clean (unstained) harborage was also included along with a treatment containing a harborage contaminated with fecal strains from placebo bait consumption (no pyriproxyfen). Following the placement of treatment harborages, a single female German cockroach prior to the hatch of the ootheca was introduced into each test arena. Upon the hatch of the ootheca, the female was removed from the test arena. Immature cockroaches were monitored weekly until adult development. Dog chow (Beneful Healthy Weight dog food: 25% crude protein, 10% crude fat and 14% moisture, Nestlé Purina, St. Louis, Mo., USA), was provided for nutrition ad libitum during the study. Individual cockroaches were scored for morphological abnormalities associated with juvenile hormone exposure when 100% adult emergence was observed in the untreated control treatment. Four (4) replications were conducted.

TABLE 2

| Treatment | Mean | | | Mean % |
|---|---|---|---|---|
| Harborage | No. | Mean % | Mean % | reproductive |
| (Type of fecal | of 1^{st} | nymphs with | adults with | adults (w/o |
| contamination | instar | severe | severe | morph- |
| on the | nymphs | morphological | morphological | ological |
| harborage) | hatched | abnormalities | abnormalities | deformities) |
| Pyriproxyfen | 40.5 | 4.8 | 95.2 | 0.0 |
| residue | | | | |
| Placebo bait | 38.75 | 1.3 | 0.0 | 98.7 |
| residue | | | | |
| No residue | 38.75 | 2.6 | 0.6 | 96.8 |
| (new | | | | |
| harborage) | | | | |

Severe morphological abnormalities associated with juvenile hormone analogue exposure strongly correlate with reproductive inhibition in German cockroaches (Reid et al. 1994, Lim and Yap 1996). The results displayed in Table 2 demonstrate that fecal pellets deposited following consumption of pyriproxyfen contain a sufficient dose of pyriproxyfen to induce 100% suppression of reproductive maturation of German cockroaches.

### Example 3

Table 3 below shows the results of an investigation aimed at demonstrating the efficacy of cockroach gel baits containing abamectin at 0.05% and pyriproxyfen at 0.50% weight concentrations.

Field evaluation of the experimental cockroach bait formulation was conducted in a public housing development that was built in 1962 with additional buildings added in 1970. The buildings are brick veneer over cinder block construction. All 458 apartment units are two-story, with living quarters downstairs (some have bathrooms downstairs), and upstairs bed and bathrooms. Individual buildings contain two, four, or eight apartment units. To determine baseline cockroach infestation levels, all apartments in select buildings were monitored using sticky traps (Lo-Line Monitor, B & G Equipment Company, Jackson, Ga.). Three traps were placed in each apartment unit: one above the kitchen sink, one below the kitchen sink, and one behind the upstairs toilet. Based upon trap capture, apartments with similar severity of cockroach infestations were assigned to treatments. Average trap catch per test unit was 217 cockroaches. Each of the test units (except the untreated controls) received 30 grams of gel bait on Day 1 of the test. In addition to the experimental bait, two commercial products were also tested. Seven test units were treated with the experimental bait, six test units were treated with commercial product standard 1, seven test units were treated with commercial product standard 2, and five test units were untreated controls. Each unit, including untested control units, was monitored (three sticky traps: one above the sink, one below the sink, and one behind the toilet) on Days 3, 7, 14, 30, 60 and 338 days after application to determine changes in trap catch and assess bait efficacy. The 7 day trap catch data was used to determine which apartments needed additional bait, and in what quantity. Additional bait quantities were applied at Day 14 in all units (except controls) according to Day 7 infestation levels (trap catch): trap catch >500 received 60 g of additional bait; catch >100 received 30 g of additional bait; catch 50-100 received 15 g of additional bait; catch <50 received 7 g of additional bait; and catch <10 received 0 g of additional bait. The change in trap catch data for each unit was averaged for each treatment and plotted over time. Trap catch data for each treatment on a particular test day was plotted as a percentage of the original trap catch recorded on Day 0 (100%). The untreated control units were treated at 60 days with a commercial product because of tenant requests.

TABLE 3

| | % Control Relative to | | |
|---|---|---|---|
| | Pre-treatment | | |
| Treatment | 14-days | 60-days | 338-days |
| Experimental Bait | 86.3 | 96.8 | 99.9 |
| (abamectin@0.05% + | | | |
| pyriproxyfen@0.50%) | | | |
| Commercial Product | 39.6 | 40.2 | 47.6 |
| Standard 1 | | | |
| Commercial Product | 82.4 | 96.0 | 64.9 |
| Standard 2 | | | |

Results displayed in Table 3 demonstrate that the combination of abamectin at 0.05% and pyriproxyfen delivered at 0.50% via cockroach bait can provide long term suppression of natural infestation of German cockroach populations.

All percent compositions are in weight percent.

### REFERENCES

Appel, A. G., Sims, S. R., Eva, M. J., 2008. Factors affecting coprophagy and necrophagy by the German cockroach (Dictyoptera: Blattellidae). Proceedings of the 6th International Conference on Urban Pests, Budapest, Hungary, 2008, pp. 139-142.
Arbes, S. J., Sever, M., Mehta, J., Gore, C. J., Schal, C., Vaughn, B., Mitchell, H., Zeldin, D. C., 2004. Abatement of cockroach allergens (Bla g 1 and Bla g 2) in low-income, urban housing: Month 12 continuation results. Journal of Allergy and Clinical Immunology, 113: 109-114.
Bell, W. J., Roth, L. M., Nalepa, C. A., 2007. Cockroaches: ecology, behavior and natural history. The Johns Hopkins University Press, Baltimore, Md.
Bloomquist, J. R. (2013). Insecticides: Chemistries and Characteristics. In: E. B. Radcliffe, W. D. Hutchison and R. E. Cancelado (eds.), Radcliffe's IPM World Textbook, URL: http://ipmworld.umn.edu, University of Minnesota, St. Paul, Minn.
Cloarec, A., Rivault, C. 1991. Age-related changes in foraging in the German cockroach (Dictyoptera: Blattellidae). Journal of Insect Behavior, 4(5): 661-673.
Cohen, A. C. 2004. Insect diets: science and technology. CRC Press, Boca Raton, Fla.
Cooper, R. A., Schal, C. (1992). Differential development and reproduction of the German cockroach (Dictyoptera: Blatlellidae) on three laboratory diets. Journal of Economic Entomology, 85: 838-844.
Dambach, M., Goehlen, B., 1999. Aggregation density and longevity correlate with humidity in first-instar nymphs of the cockroach (Blattella germanica L., Dictyoptera). Journal of Insect Physiology, 45: 423-429.
Fisher, M. H., Mrozik, H. 1992. The chemistry and pharmacology of avermectins. Annual Review of Pharmacology and Toxicology, 32: 537-553.
Graczyk, T. K., Knight, R., Tamang, L., 2005. Mechanical transmission of human protozoan parasites by insects. Clinical Microbiology Reviews, 18: 128-132.
Gunn, D. L. 1935. The temperature and humidity relations of the cockroach. III. A comparison of temperature preference, desiccation and respiration of Periplaneta americana, Blatta orientalis and Blattella germanica. Journal of Experimental Biology, 13: 185-90.
Hamilton, R. L., Schal, C. 1998. Effects of dietary protein levels on reproduction and food consumption in the German cockroach (Dictyoptera: Blattellidae). Annals of the Entomological Society of America, 8: 969-976.
Haydak, M. H. 1953. Influence of the protein level of the diet on the longevity of cockroaches. Annals of the Entomological Society of America, 46: 547-560.
Kells, S. M., Voght, J. T., Appel, A. G., Bennett, G. W., 1999. Estimating nutritional status of German cockroaches, Blattella germanica (L.) (Dictyoptera: Blattellidae), in the field. Journal of Insect Physiology, 45: 709-717.
Kopanic, R. J., Holbrook, G. L., Sevala, V., Schal, C., 2001. An adaptive benefit of facultative coprophagy in the German cockroach Blattella germanica. Ecological Entomology, 26: 154-162.
Lim, L. J., Yap, H. H., 1996. Induction of wing twisting abnormalities and sterility on German cockroaches (Dictyoptera: Blattellidae) by a juvenoid pyriproxyfen. Journal of Economic Entomology, 89: 1161-1165.
McCay, C. M. 1938. The nutritional requirements of Blattella germanica, Physiological Zoology, 11: 89-103.
Noland, J. L., Baumann, C. L., 1951. Protein requirements of the cockroach, Blattella germanica (L.). Annals of the Entomological Society of America, 162: 184-188.
Reid, B. L., Brock, V. L., Bennett, G. W., 1994. Developmental, morphogenetic and reproductive effects of four polycyclic non-isoprenoid juvenoids in the German cockroach (Dictyoptera: Blattellidae). Journal of Entomological Science, 29: 31-42.
Rivault, C. 1997. Distribution dynamics of Blattella germanica in a closed urban environment. Entomologia Experimentalis et Applicata, 57: 85-91.
Rivault, C., Durier, V., Cloarec, A., 1999. How do Blattella germancia (L.) aggregate? Proceedings of the 3′ International Conference on Urban Pests, Prague, Czech Republic, 1999, pp. 104-111.
Rust, M. K. 2008. Cockroaches, pp. 53-57. In Bonnefoy, X, H. Kampen, and K. Sweeney (eds.), Public Health Significance of Urban Pests. WHO Regional Office for Europe, Denmark.
Schal, C., Holbrook, G. L., Bachmann, J. A. S., Sevala, V. L. 1997. Reproductive biology of the German cockroach, Blattella germanica: Juvenile hormone as a pleiotropic master regulator. Archives of Insect Biochemistry and Physiology, 35: 405-426.
Stejskal, V. 1997. Distribution of faeces of the German cockroach, Blattella germanica. Entomologia Experimentalis et Applicata, 84: 201-205.

Although particular embodiments have been disclosed herein in detail, this has been done for purposes of illustration only, and is not intended to be limiting with respect to the scope of the claims. In particular, it is contemplated that various substitutions, alterations, and modifications may be made to the invention without departing from the spirit and scope of the invention as defined by the claims.

What is claimed is:

1. A method of reducing a population of cockroaches comprising:
providing a cockroach bait comprising a bait matrix, an insect growth regulator, and a non-insect growth regulator insecticide; and
placing the cockroach bait in a location where cockroaches are periodically present, to thereby reduce the population of cockroaches in the vicinity of the location,
wherein the non-insect growth regulator insecticide is an avermectin or milbemycin insecticide.

2. The method of claim 1, wherein the insect growth regulator is present in the bait at a concentration of from 0.05 to 5 percent by weight.

3. The method of claim 1, wherein the insect growth regulator is present in the bait at a concentration of from 0.25 to 1 percent by weight.

4. The method of claim 1, wherein the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, isomers thereof, and combinations thereof.

5. The method of claim 1, wherein the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof.

6. The method of claim 1, wherein the insect growth regulator is selected from pyriproxyfen, hydroprene, kinoprene, methoprene, and fenoxycarb.

7. The method of claim 1, wherein the insect growth regulator is pyriproxyfen.

8. The method of claim 1, wherein the non-insect growth regulator insecticide is present in the bait at a concentration of from 0.01 to 5 percent by weight.

9. The method of claim 1, wherein the non-insect growth regulator insecticide is present in the bait at a concentration of from 0.025 to 1 percent by weight.

10. The method of claim 1, wherein the non-insect growth regulator insecticide is an avermectin insecticide.

11. The method of claim 10, wherein the avermectin insecticide is selected from abamectin, emamectin benzoate, emamectin, ivermectin, selamectin, doramectin, isomers thereof, salts thereof, and combinations thereof.

12. The method of claim 10, wherein the avermectin insecticide is selected from abamectin, emamectin benzoate, emamectin, ivermectin, selamectin, doramectin, salts thereof, and combinations thereof.

13. The method of claim 1, wherein the non-insect growth regulator insecticide is a milbemycin insecticide.

14. The method of claim 13, wherein the milbemycin insecticide is selected from lepimectin, milbemectin, milbemycin oxime, moxidectin, nemadectin, isomers thereof, salts thereof, and combinations thereof.

15. The method of claim 13, wherein the milbemycin insecticide is selected from lepimectin, milbemectin, milbemycin oxime, moxidectin, nemadectin, salts thereof, and combinations thereof.

16. The method of claim 1, wherein the non-insect growth regulator insecticide is selected from abamectin, emamectin benzoate, lepimectin, and milbemectin.

17. The method of claim 1, wherein the non-insect growth regulator insecticide is abamectin.

18. The method of claim 1, wherein the insect growth regulator is pyriproxyfen and the non-insect growth regulator insecticide is abamectin.

19. The method of claim 18, wherein pyriproxyfen and abamectin are the only active ingredients.

20. The method of claim 18, wherein the pyriproxyfen is present in the bait at a concentration of from 0.05 to 1 percent by weight and the abamectin is present in the bait at a concentration of from 0.025 to 1 percent by weight.

21. The method of claim 18, wherein the pyriproxyfen is present in the bait at a concentration of from 0.05 to 1 percent by weight and the abamectin is present in the bait at a concentration of from 0.025 to 0.25 percent by weight.

22. The method of claim 18, wherein the pyriproxyfen is present in the bait at a concentration of 0.5 percent by weight and the abamectin is present in the bait at a concentration of 0.05 percent by weight.

23. The method of claim 1, wherein the cockroaches are German cockroaches.

24. The method of claim 1, wherein the population of cockroaches in the vicinity of the location is reduced by 30% or more two months after the cockroach bait has been placed.

25. The method of claim 1, wherein the population of cockroaches in the vicinity of the location is reduced by 50% or more two months after the cockroach bait has been placed.

26. The method of claim 1, wherein the population of cockroaches in the vicinity of the location is reduced by 70% or more two months after the cockroach bait has been placed.

27. The method of claim 1, wherein the population of cockroaches in the vicinity of the location is reduced by 90% or more two months after the cockroach bait has been placed.

28. The method of claim 1, wherein the population of cockroaches in the vicinity of the location is reduced by 30% or more one year after the cockroach bait has been placed.

29. The method of claim 1, wherein the population of cockroaches in the vicinity of the location is reduced by 50% or more one year after the cockroach bait has been placed.

30. The method of claim 1, wherein the population of cockroaches in the vicinity of the location is reduced by 70% or more one year after the cockroach bait has been placed.

31. The method of claim 1, wherein the population of cockroaches in the vicinity of the location is reduced by 90% or more one year after the cockroach bait has been placed.

32. A cockroach bait comprising a bait matrix, an insect growth regulator, and a non-insect growth regulator insecticide, wherein the non-insect growth regulator insecticide is an avermectin or milbemycin insecticide.

33. The cockroach bait of claim 32, wherein the insect growth regulator is present in the bait at a concentration of from 0.05 to 5 percent by weight.

34. The cockroach bait of claim 32, wherein the insect growth regulator is present in the bait at a concentration of from 0.25 to 1 percent by weight.

35. The cockroach bait of claim 32, wherein the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, isomers thereof, and combinations thereof.

36. The cockroach bait of claim 32, wherein the insect growth regulator is selected from pyriproxyfen, hydroprene, kinoprene, methoprene, fenoxycarb, bistrifluron, chlorfluazuron, diflubenzuron, flucycloxuron, flufenoxuron, hexaflumuron, lufenuron, novaluron, noviflumuron, teflubenzuron, triflumuron, buprofezin, cyromazine, chromafenozide, halofenozide, methoxyfenozide, tebufenozide, clofentezine, hexythiazox, diflovidazin, azadirachtin, salts thereof, and combinations thereof.

37. The cockroach bait of claim 32, wherein the insect growth regulator is selected from pyriproxyfen, hydroprene, kinoprene, methoprene, and fenoxycarb.

38. The cockroach bait of claim 32, wherein the insect growth regulator is pyriproxyfen.

39. The cockroach bait of claim 32, wherein the non-insect growth regulator insecticide is present in the bait at a concentration of from 0.01 to 5 percent by weight.

40. The cockroach bait of claim 32, wherein the non-insect growth regulator insecticide is present in the bait at a concentration of from 0.025 to 1 percent by weight.

41. The cockroach bait of claim 32, wherein the non-insect growth regulator insecticide is an avermectin insecticide.

42. The cockroach bait of claim 41, wherein the avermectin insecticide is selected from abamectin, emamectin benzoate, emamectin, ivermectin, selamectin, doramectin, isomers thereof, salts thereof, and combinations thereof.

43. The cockroach bait of claim 41, wherein the avermectin insecticide is selected from abamectin, emamectin benzoate, emamectin, ivermectin, selamectin, doramectin, salts thereof, and combinations thereof.

44. The cockroach bait of claim 32, wherein the non-insect growth regulator insecticide is a milbemycin insecticide.

45. The cockroach bait of claim 44, wherein the milbemycin insecticide is selected from lepimectin, milbemectin, milbemycin oxime, moxidectin, nemadectin, isomers thereof, salts thereof, and combinations thereof.

46. The cockroach bait of claim 44, wherein the milbemycin insecticide is selected from lepimectin, milbemectin, milbemycin oxime, moxidectin, nemadectin, salts thereof, and combinations thereof.

47. The cockroach bait of claim 32, wherein the non-insect growth regulator insecticide is selected from abamectin, emamectin benzoate, lepimectin, and milbemectin.

48. The cockroach bait of claim 32, wherein the non-insect growth regulator insecticide is abamectin.

49. A cockroach bait comprising a bait matrix, pyriproxyfen, and abamectin.

50. The cockroach bait of claim 49, wherein pyriproxyfen and abamectin are the only active ingredients.

51. The cockroach bait of claim 49, wherein the pyriproxyfen is present in the bait at a concentration of from 0.05 to 1 percent by weight and the abamectin is present in the bait at a concentration of from 0.025 to 1 percent by weight.

52. The cockroach bait of claim 49, wherein the pyriproxyfen is present in the bait at a concentration of from 0.05 to 1 percent by weight and the abamectin is present in the bait at a concentration of from 0.025 to 0.25 percent by weight.

53. The cockroach bait of claim 49, wherein the pyriproxyfen is present in the bait at a concentration of 0.5 percent by weight and the abamectin is present in the bait at a concentration of 0.05 percent by weight.
